(19) United States
(12) Patent Application Publication
(10) Pub. No.: US 2023/0325318 A1
(43) Pub. Date: Oct. 12, 2023

(54) COMPUTER-READABLE RECORDING MEDIUM STORING SCHEDULING PROGRAM, SCHEDULING METHOD, AND INFORMATION PROCESSING DEVICE

(71) Applicant: Fujitsu Limited, Kawasaki-shi (JP)

(72) Inventor: Satoshi IWATA, Madison, WI (US)

(73) Assignee: Fujitsu Limited, Kawasaki-shi (JP)

(21) Appl. No.: 18/152,180

(22) Filed: Jan. 10, 2023

(30) Foreign Application Priority Data
Apr. 7, 2022 (JP) 2022-064168

(51) Int. Cl. G06F 12/084

(52) U.S. Cl. CPC G06F 12/084

(57) ABSTRACT

A non-transitory computer-readable recording medium stores a scheduling program for causing a computer to execute processing including: acquiring first information that indicates the number of accesses per unit time for a cache memory, for each of a plurality of jobs that is able to share the cache memory; acquiring second information that indicates a change amount of an execution time when each job is executed while changing a cache memory amount available for each job, for each job; and determining a combination of jobs to be simultaneously executed, among the plurality of jobs, based on the acquired first information and second information.

### CROSS-REFERENCE TO RELATED APPLICATION

This application is based upon and claims the benefit of priority of the prior Japanese Patent Application No. 2022-64168, filed on Apr. 7, 2022, the entire contents of which are incorporated herein by reference.

### FIELD

The embodiment discussed herein is related to a scheduling program, a scheduling method, and an information processing device.

### BACKGROUND

Typically, in order to bridge a gap between a processing speed of a central processing unit (CPU) and an access speed of a main memory, a cache memory may be implemented in the CPU. Although the cache memory can be accessed at higher speed than the main memory, the cache memory has a smaller capacity than the main memory. Therefore, the cache memory is used to temporarily store data that is frequently accessed among data stored in the main memory, for example.

Japanese Laid-open Patent Publication No. 2017-073045, U.S. Patent Application Publication No. 2018/0309692, Japanese Laid-open Patent Publication No. 2009-245055, Japanese Laid-open Patent Publication No. 2022-012115, and U.S. Patent Application Publication No. 2009/0083488 are disclosed as related art.

### SUMMARY

According to an aspect of the embodiments, a non-transitory computer-readable recording medium stores a scheduling program for causing a computer to execute processing including: acquiring first information that indicates the number of accesses per unit time for a cache memory, for each of a plurality of jobs that is able to share the cache memory; acquiring second information that indicates a change amount of an execution time when each job is executed while changing a cache memory amount available for each job, for each job; and determining a combination of jobs to be simultaneously executed, among the plurality of jobs, based on the acquired first information and second information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a scheduling method according to an embodiment;

FIG. 2 is a block diagram illustrating a hardware configuration example of a job scheduling device 200;

FIG. 3 is an explanatory diagram illustrating a system configuration example of the job scheduling device 200;

FIG. 4 is an explanatory diagram illustrating a specific example of performance information;

FIG. 5 is a block diagram illustrating a functional configuration example of the job scheduling device 200;

FIG. 6 is an explanatory diagram illustrating an example of stored content of an access characteristic table 600;

FIG. 7 is an explanatory diagram illustrating an example of stored content of a performance change table 700;

FIG. 8 is an explanatory diagram illustrating an example of stored content of a classification result table 800;

FIG. 9 is an explanatory diagram illustrating a specific example of priority order information;

FIG. 10 is an explanatory diagram illustrating a job execution example;

FIG. 11 is a flowchart illustrating an example of an offline processing procedure of the job scheduling device 200;

FIG. 12 is a flowchart illustrating an example of a specific processing procedure of first analysis processing;

FIG. 13 is a flowchart illustrating an example of a specific processing procedure of second analysis processing;

FIG. 14 is a flowchart illustrating an example of a job scheduling processing procedure of the job scheduling device 200;

FIG. 15 is a flowchart illustrating an example of a specific processing procedure of job determination processing;

FIG. 16 is a flowchart illustrating an example of a specific processing procedure of first selection processing;

FIG. 17 is a flowchart illustrating an example of a specific processing procedure of second selection processing;

FIG. 18 is a flowchart illustrating an example of a specific processing procedure of third selection processing;

FIG. 19 is a flowchart illustrating an example of a specific processing procedure of fourth selection processing; and

FIG. 20 is an explanatory diagram illustrating another system configuration example.

### DESCRIPTION OF EMBODIMENTS

As a related art, for example, there is a technique for determining a physical server to be an arrangement determination of a new virtual machine by avoiding arranging a sensitive virtual machine with a high first evaluation value and a virtual machine with a high second evaluation value that causes a dirty cache on the same physical server. Furthermore, there is a technique for selecting a computing node based on a competition score regarding a competition of caches of the computing nodes in response to a request of a new virtual machine and scheduling a new virtual machine with the selected computing node.

Furthermore, there is a technique for performing exclusive control between tasks in which a plurality of processes including processes that cannot be mutually executed in parallel is combined in an inseparable format. Furthermore, there is a technique for generating a schedule for executing a processing group by a multi-core processor that includes a core group and memory resources that includes a shared memory shared by a plurality of cores in the core group. Furthermore, there is a technique for receiving a bus message with a first cache corresponding to a speculative access to a part of a second cache by a second thread and determining whether or not there is a dependence relationship between threads.

However, with the related art, when a plurality of jobs is executed, it is difficult to schedule the jobs in consideration of a performance change due to an effect of a cache memory shared between the jobs.

In one aspect, an object of the embodiment is to determine a combination of jobs to be simultaneously executed in consideration of a performance change due to an effect of a cache memory shared between the jobs.

Hereinafter, embodiments of a scheduling program, a scheduling method, and an information processing device according to the present disclosure will be described in detail with reference to the drawings.

### Embodiment

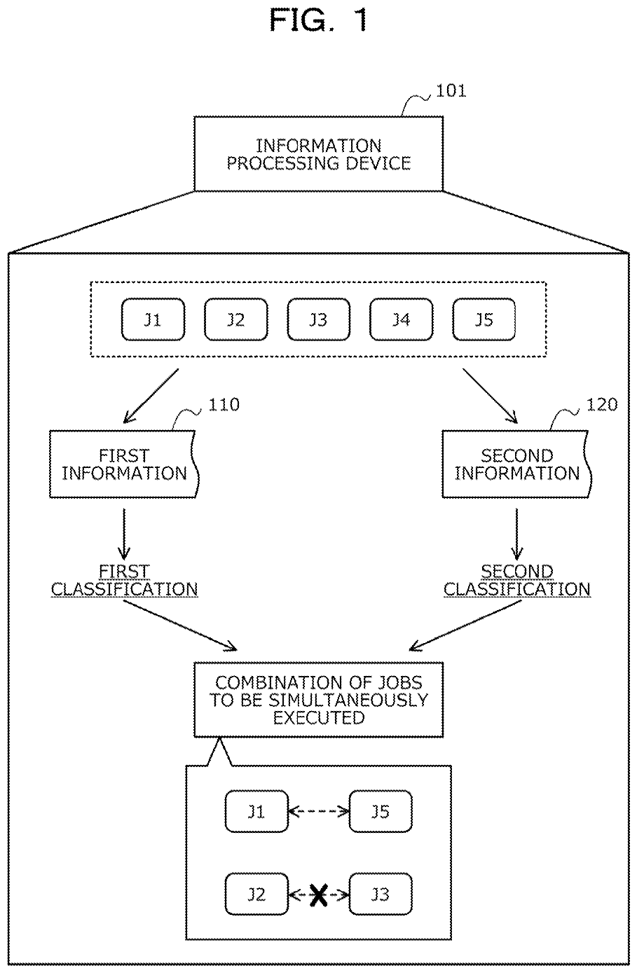

FIG. 1 is an explanatory diagram illustrating an example of a scheduling method according to an embodiment. In FIG. 1, an information processing device 101 is a computer that schedules jobs. The job is a unit of a processing work of a computer, and includes, for example, programs processed as one group, of a series of programs. Job scheduling is to determine how to combine a plurality of jobs and execute the jobs.

Here, a cache memory is a storage device provided between a CPU and a main memory (main storage device) and is used as a temporary storage destination of data. The cache memory may be mounted on a chip of the CPU or may be mounted outside the chip of the CPU. By storing frequently accessed data in the cache memory, it is possible to reduce the number of times of access to the main storage device and increase a processing speed of the computer.

The cache memory may be, for example, layered, and a primary cache, a secondary cache, and a tertiary cache may be implemented in order in which an access at high speed can be performed. The primary cache and the secondary cache are often prepared for each core of the CPU. On the other hand, the tertiary cache is often shared and used among a plurality of cores.

Some programs use a lot of cache memory and some do not. Therefore, a design is often adopted in which one large cache memory is shared by all cores so as to allocate a large amount of the cache memory to a program that uses much cache memory and allocate a small amount of the cache memory to a program that uses less cache memory.

However, an access pattern to the cache memory differs for each program. Therefore, depending on a combination of jobs (program) that are simultaneously executed, a performance is deteriorated or improved due to an effect of the cache memory shared between the jobs. In order to confirm the effect between the jobs on each other, it is considered to confirm an effect on a performance by simultaneously executing the plurality of jobs. However, it takes time and it is not realistic to confirm the effects on all the combinations of the jobs by simultaneously executing the jobs actually.

Here, the jobs can be classified into a job that has a strong tendency to deprive a cache memory and a job that has a strong tendency to be deprived a cache memory in a case where the job is simultaneously executed with other jobs, according to access characteristics to the cache memory. The job that deprives the cache memory is a job that uses much of the shared cache memory when being simultaneously executed with the other jobs. The job from which the cache memory is deprived is a job that yields the cache memory to the other jobs and uses a relatively small amount of the cache memory when being simultaneously executed with the other jobs.

Furthermore, there is a case where a cache memory amount available for a job and a job execution performance is not proportional. A factor that causes the unproportional relationship includes a cache reusability of a job. If data cached in the cache memory is not reused for a long period, the data is replaced with another data. A job with a high cache reuse rate tends to have a higher performance as an available cache memory amount is larger. On the other hand, for a job with a low cache reuse rate, there is a case where the performance does not become very high even if the available cache memory amount is large.

Therefore, in the present embodiment, a scheduling method will be described for determining a combination of jobs to be simultaneously executed, in consideration of a performance change due to an effect of a cache memory that is shared between the jobs, from access characteristics of each job to the cache memory and a performance change of each job caused by a change in the available cache memory amount. Here, a processing example of the information processing device 101 will be described.

(1) The information processing device 101 acquires first information 110 that indicates the number of accesses to the cache memory per unit time, for each of the plurality of jobs that can share the cache memory. Here, it can be said that a job with a large number of accesses is more likely to dominate more cache memory than a job with a small number of accesses.

Here, in order to determine whether or not each job tends to deprive the cache memory or tends to be deprived the cache memory, the number of accesses to the cache memory per unit time is used. The number of accesses per unit time is obtained, for example, by measuring the number of loads per unit time when each job is executed alone. The number of loads is the number of reads from the cache memory per unit time.

In the example in FIG. 1, the plurality of jobs that can share the cache memory is assumed as “jobs J1 to J5”. In this case, the first information 110 indicates the number of accesses to a cache memory of each of the jobs J1 to J5 per unit time.

(2) The information processing device 101 acquires second information 120 that indicates a change amount of an execution time when each job is executed while changing a cache memory amount that is available for each job, for each job. Here, in order to determine a job of which a performance largely changes due to the change in the cache memory amount and a job of which a performance does not largely change, this change amount of the execution time is used.

In the example in FIG. 1, the second information 120 indicates a change amount of an execution time when each of the jobs J1 to J5 is executed while changing a cache memory amount that is available for each of the jobs J1 to J5.

(3) The information processing device 101 determines a combination of jobs to be simultaneously executed, among the plurality of jobs, based on the acquired first information 110 and second information 120. For example, the information processing device 101 performs first classification based on the first information 110. The first classification is processing for classifying the plurality of jobs into a job that has a first tendency for tending to deprive a cache memory and a job that has a second tendency for tending to be deprived a cache memory.

Furthermore, the information processing device 101 performs second classification based on the second information 120. The second classification is processing for classifying the plurality of jobs into a job that has a third tendency of which a performance easily changes according to the change in the cache memory amount and a job that has a fourth tendency of which a performance does not easily change according to the change in the cache memory amount.

Then, the information processing device 101 determines a combination of jobs to be simultaneously executed, among the plurality of jobs, based on the classified results (first classification result and second classification result). For example, the information processing device 101 determines a combination of jobs to be simultaneously executed so as to combine and execute a job that has the first tendency and the third tendency and a job that has the second tendency and the fourth tendency, among the plurality of jobs.

The job that has the first tendency and the third tendency is a job that tends to deprive the cache memory and of which the performance easily changes according to the change in the cache memory amount. The job that has the second tendency and the fourth tendency is a job that tends to be deprived the cache memory and of which the performance does not easily change according to the change in the cache memory amount.

Furthermore, the information processing device 101 determines a combination of jobs to be simultaneously executed so as not to combine and execute a job that has the first tendency and the fourth tendency and a job that has the second tendency and the third tendency, among the plurality of jobs. The job that has the first tendency and the fourth tendency is a job that tends to deprive the cache memory and of which the performance does not easily change according to the change in the cache memory amount. The job that has the second tendency and the third tendency is a job that tends to be deprived the cache memory and of which the performance easily changes according to the change in the cache memory amount.

In the example in FIG. 1, the job that has the first tendency and the third tendency is assumed as the “job J1”. Furthermore, the job that has the second tendency and the fourth tendency is assumed as the “job J5”. In this case, the information processing device 101 determines a combination of jobs to be simultaneously executed so as to combine and execute the jobs J1 and J5, among the jobs J1 to J5.

Furthermore, the job that has the first tendency and the fourth tendency is assumed as the “job J2”. Furthermore, the job that has the second tendency and the third tendency is assumed as the “job J3”. In this case, the information processing device 101 determines a combination of jobs to be simultaneously executed so as not to combine and execute the jobs J2 and J3, among the jobs J1 to J5.

In this way, according to the information processing device 101, it is possible to determine the combination of the jobs to be simultaneously executed in consideration of the performance change due to the effect of the cache memory shared between the jobs. As a result, for example, the information processing device 101 can suppress a performance deterioration of the job that has a strong tendency to be deprived the cache memory while bringing out the performance of the job that has a strong tendency to deprive the cache memory.

In the example in FIG. 1, the information processing device 101 simultaneously executes, for example, the jobs J1 and J5, among the jobs J1 to J5. As a result, the job J1 can use a large amount of the cache memory, and a performance of the job J1 can be improved. On the other hand, even if the job J1 deprives the cache memory of the job J5, deterioration in a performance of the job J5 can be suppressed.

Furthermore, the information processing device 101 does not simultaneously execute, for example, the jobs J2 and J3, among the jobs J1 to J5. As a result, it is possible to prevent a performance deterioration (disadvantage) caused by reduction of the cache memory amount of the job J3 from being larger than a performance improvement (advantage) caused by increase in the cache memory amount of the job J2. As a result, the information processing device 101 can obtain a high execution performance as a whole.

(Hardware Configuration Example of Job Scheduling Device 200)

In the following description, a case will be described where the information processing device 101 illustrated in FIG. 1 is applied to a job scheduling device 200. The job scheduling device 200 is a computer that schedules jobs. Furthermore, the job scheduling device 200 executes the scheduled jobs, for example. The job scheduling device 200 is, for example, a server. However, the job scheduling device 200 may be implemented by a personal computer (PC).

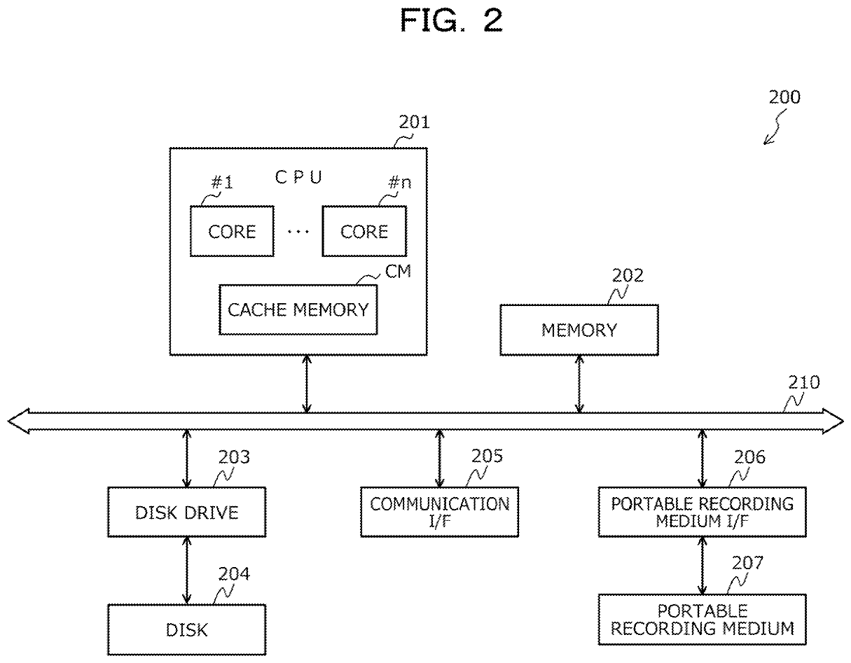

First, a hardware configuration example of the job scheduling device 200 will be described with reference to FIG. 2.

FIG. 2 is a block diagram illustrating the hardware configuration example of the job scheduling device 200. In FIG. 2, the job scheduling device 200 includes a central processing unit (CPU) 201, a memory 202, a disk drive 203, a disk 204, a communication interface (I/F) 205, a portable recording medium I/F 206, and a portable recording medium 207. Furthermore, the individual components are coupled to each other with a bus 210.

Here, the CPU 201 performs overall control of the job scheduling device 200. The CPU 201 includes cores #1 to #n and a cache memory CM. Each core #i is an arithmetic circuit in the CPU 201 (i=1, 2, . . . , n). The cache memory CM is a storage device provided between the CPU 201 and the memory 202 and is used as a temporary storage destination of data.

The cache memory CM corresponds to, for example, a cache memory (tertiary cache) that is shared between the cores #1 to #n, among layered cache memories. For example, the cache memory CM corresponds to a last level cache (LLC). In the following description, the cache memory CM may be described as the last level cache (LLC). Furthermore, unless otherwise specified, a case will be described as an example where the cores #1 to #n are cores #1 and #2 (n=2) and two jobs are simultaneously executed on the same CPU 201.

The memory 202 includes, for example, a read only memory (ROM), a random access memory (RAM), a flash ROM, or the like. For example, the flash ROM stores operating system (OS) programs, the ROM stores application programs, and the RAM is used as a work area for the CPU 201. The program stored in the memory 202 is loaded to the CPU 201 to cause the CPU 201 to execute coded processing.

The disk drive 203 controls reading and writing of data from and to the disk 204 under the control of the CPU 201. The disk 204 stores data written under the control of the disk drive 203. Examples of the disk 204 include a magnetic disk, an optical disk, or the like.

The communication I/F 205 is coupled to a network through a communication line, and is coupled to an external computer through the network. Then, the communication I/F 205 manages an interface between the network and the inside of the device, and controls input and output of data to and from the external computer. For example, a modem, a LAN adapter, or the like may be adapted as the communication I/F 205.

The portable recording medium I/F 206 controls reading and writing of data from and to the portable recording medium 207 under the control of the CPU 201. The portable recording medium 207 stores data written under the control of the portable recording medium I/F 206. Examples of the portable recording medium 207 include a compact disc (CD)-ROM, a digital versatile disk (DVD), a universal serial bus (USB) memory, or the like.

Note that the job scheduling device 200 may include, for example, an input device, a display, or the like, in addition to the components described above. Furthermore, the job scheduling device 200 does not have to include, for example, the portable recording medium I/F 206 and the portable recording medium 207, among the components described above.

(System Configuration Example of Job Scheduling Device 200)

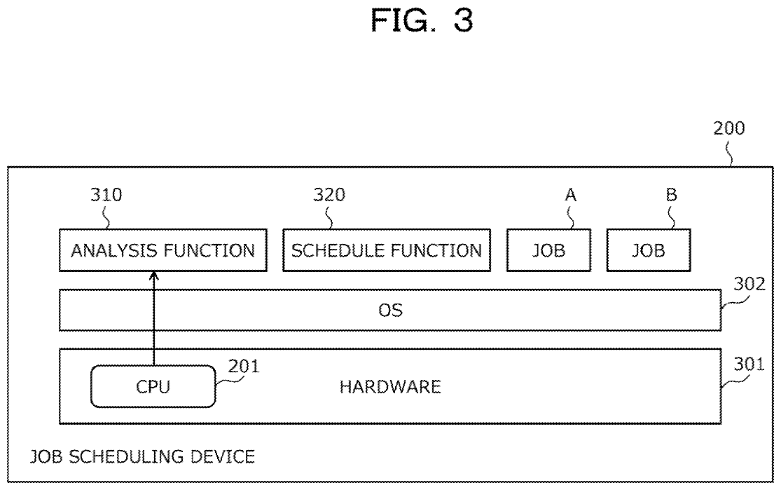

Next, a system configuration example of the job scheduling device 200 will be described with reference to FIG. 3.

FIG. 3 is an explanatory diagram illustrating the system configuration example of the job scheduling device 200. In FIG. 3, the job scheduling device 200 includes hardware 301 and an OS 302. The hardware 301 includes, for example, the CPU 201 through the portable recording medium 207 illustrated in FIG. 2. In FIG. 3, only the CPU 201 is illustrated.

The OS 302 is software that manages an entire system of a computer and provides a common usage environment for various applications. On the OS 302, for example, an analysis function 310 and a schedule function 320 are operated. Furthermore, on the OS 302, jobs that are requested to be executed (jobs A and B in example in FIG. 3) are operated.

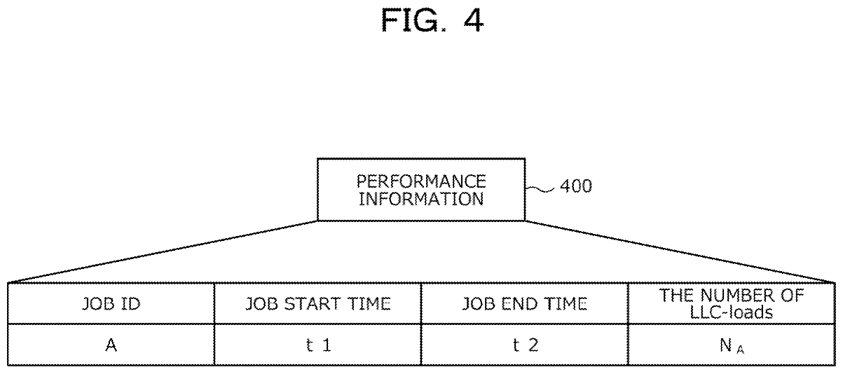

The analysis function 310 analyzes an access pattern of each job to the cache memory CM, based on performance information from the CPU 201 (for example, refer to FIG. 4 described later). Furthermore, the analysis function 310 analyzes a performance change of each job according to a change in the available cache memory amount, based on the performance information. The schedule function 320 schedules the jobs that are requested to be executed.

The analysis function 310 and the schedule function 320 may be implemented by the same application or may be implemented by different applications, for example.

(Specific Example of Performance Information)

Next, a specific example of the performance information will be described with reference to FIG. 4. The performance information can be acquired in a form of a performance counter from the CPU 201 via the OS 302, for example, as illustrated in FIG. 3.

FIG. 4 is an explanatory diagram illustrating a specific example of the performance information. In FIG. 4, performance information 400 includes a job ID, a job start time, a job end time, and the number of LLC-loads. The job ID is an identifier that uniquely identifies a job. The job start time is a time when execution of a job is started. The job end time is a time when the execution of the job ends.

The number of LLC-loads is obtained by counting reads from a last level cache (LLC) during the job execution in the CPU 201 (for example, refer to FIGS. 2 and 3). According to the performance information 400, a job start time t1, a job end time t2, and the number of LLC-loads N_{A} of the job A can be specified.

(Functional Configuration Example of Job Scheduling Device 200)

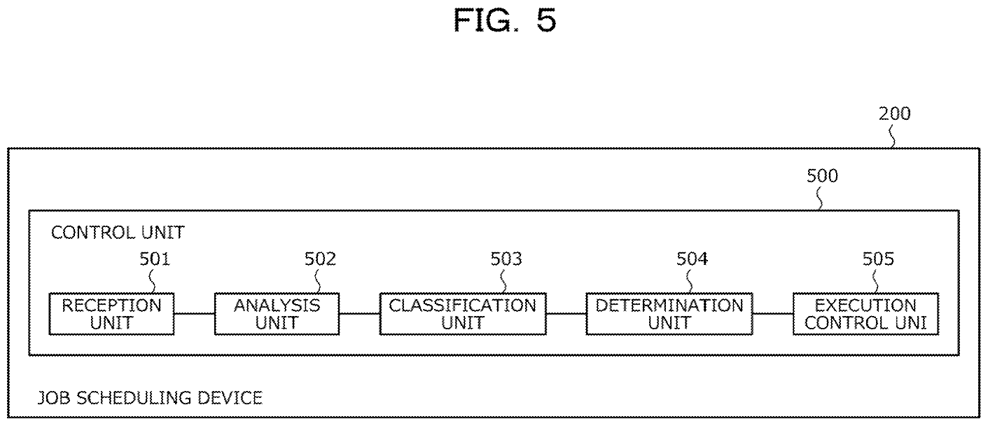

Next, a functional configuration example of the job scheduling device 200 will be described with reference to FIG. 5.

FIG. 5 is a block diagram illustrating the functional configuration example of the job scheduling device 200. In FIG. 5, the job scheduling device 200 includes a reception unit 501, an analysis unit 502, a classification unit 503, a determination unit 504, and an execution control unit 505. The reception unit 501 through the execution control unit 505 are functions to be a control unit 500, and for example, the functions are implemented by causing the CPU 201 to execute programs stored in a storage device such as the memory 202, the disk 204, or the portable recording medium 207 illustrated in FIG. 2 or by the communication I/F 205. A processing result of each functional unit is stored, for example, in a storage device such as the memory 202 or the disk 204. The analysis function 310 illustrated in FIG. 3 is implemented, for example, by the reception unit 501, the analysis unit 502, and the classification unit 503. Furthermore, the schedule function 320 illustrated in FIG. 3 is implemented, for example, by the determination unit 504 and the execution control unit 505.

The reception unit 501 receives execution requests of a plurality of jobs. The execution request of the plurality of jobs includes a job ID of each job to be executed. The plurality of jobs can share the cache memory CM (refer to FIG. 2). For example, each job is executed by each core #i (refer to FIG. 2) and shares the cache memory CM.

For example, the reception unit 501 receives the execution requests of the plurality of jobs from a client terminal (not illustrated). The client terminal is a computer used by a user. Furthermore, the reception unit 501 may receive the execution requests of the plurality of jobs through an operation input of the user using an input device (not illustrated).

In the following description, the plurality of jobs that is requested to be executed may be referred to as “jobs J1 to Jm” (m is natural number that is equal to or more than two). Furthermore, any one job of the jobs J1 to Jm may be referred to as a “job Jk” (k=1, 2, . . . , m).

The analysis unit 502 acquires access characteristics information (first information) that indicates the number of accesses to the cache memory CM per unit time, for each job Jk among the jobs J1 to Jm that can share the cache memory CM. As the number of accesses, for example, the number of reads (the number of loads) from the cache memory CM can be used.

For example, the analysis unit 502 acquires the performance information (for example, performance information 400 illustrated in FIG. 4) from the OS 302 illustrated in FIG. 3, by executing each job Jk alone offline. The offline is to execute the job Jk prior to an actual operation. At this time, the analysis unit 502 executes each job Jk, for example, under an environment where all the cache memory CM can be used.

Next, the analysis unit 502 refers to the acquired performance information and calculates an execution time of the job Jk from the job start time and the job end time. Then, the analysis unit 502 refers to the acquired performance information and calculates the number of LLC-loads per unit time from the calculated execution time and number of LLC-loads.

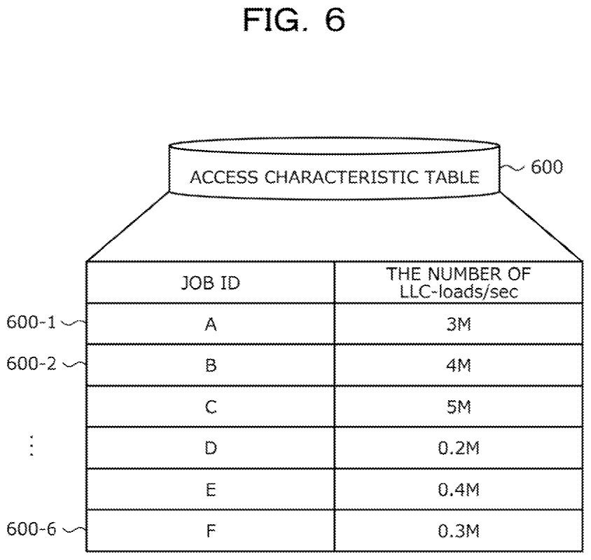

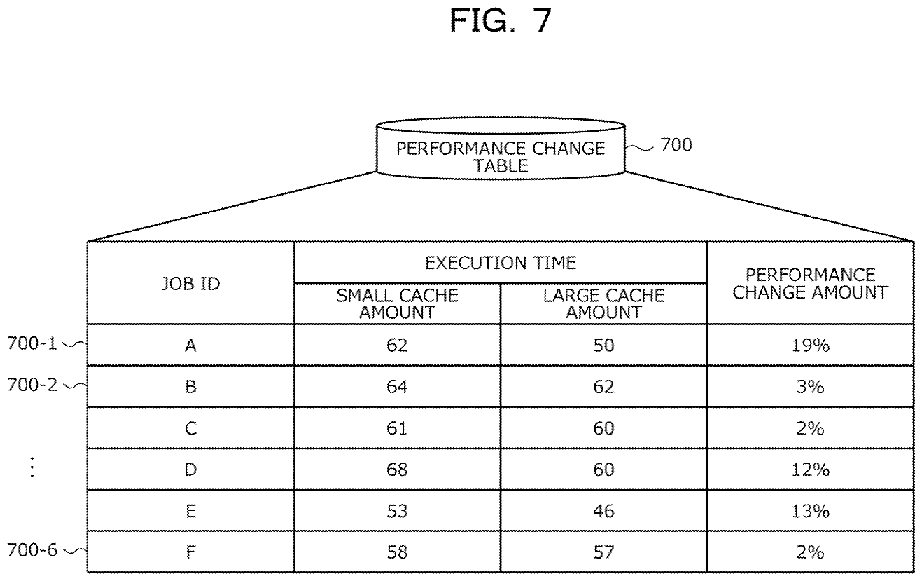

The calculated execution time is stored in a performance change table 700 as illustrated in FIG. 7, for example, in association with a job ID of the job Jk. Furthermore, the calculated number of LLC-loads per unit time is stored in an access characteristic table 600 as illustrated in FIG. 6, for example, in association with the job ID of the job Jk.

Here, stored content of the access characteristic table 600 will be described. The access characteristic table 600 is implemented, for example, by a storage device such as the memory 202 or the disk 204. Here, jobs A to F will be described as examples of the jobs J1 to Jm.

FIG. 6 is an explanatory diagram illustrating an example of the stored content of the access characteristic table 600. In FIG. 6, the access characteristic table 600 includes fields of a job ID and the number of LLC-loads/sec, and stores pieces of access characteristics information 600-1 to 600-6 as records by setting information in each field.

Here, the job ID is an identifier that uniquely identifies the job Jk. The number of LLC-loads/sec indicates the number of LLC-loads per unit time during execution of the job Jk. For example, the access characteristics information 600-1 indicates the number of LLC-loads/sec “3 mega (M)” of the job A.

As a result, the analysis unit 502 can acquire access characteristics information (for example, access characteristics information 600-1 to 600-6) that indicates the number of accesses to the cache memory CM per unit time, for each job Jk. The first information 110 illustrated in FIG. 1 corresponds to, for example, the access characteristic table 600.

Furthermore, the analysis unit 502 acquires performance change information (second information) that indicates a change amount of an execution time when each job Jk is executed while changing a cache memory amount that is available for each job Jk, for each job Jk of the jobs J1 to Jm. For example, the analysis unit 502 measures an execution time under an environment in which the cache memory CM is not limited and an execution time under an environment in which the cache memory CM is limited, for each job Jk.

Here, the environment in which the cache memory CM is not limited is an environment in which each job Jk can use all the cache memory CM. The execution time of each job Jk under the environment in which the cache memory CM is not limited (large cache amount) is, for example, calculated at the time when the number of LLC-loads of each job Jk described above is calculated and stored in the performance change table 700.

Furthermore, the environment in which the cache memory CM is limited is an environment in which the cache memory CM that can be used by each job Jk is limited. The environment in which the cache memory CM is limited can be realized by using a function called the Cache Allocation Technology included in the Resource Director Technology, for example, in a case of an environment of the Intel CPU. This function is a function that can change an available cache memory amount.

For example, the analysis unit 502 acquires the performance information from the OS 302, by executing each job Jk alone online, under an environment in which the available cache memory amount is limited to be minimum. The cache memory amount limited to be minimum is, for example, about 1/10 of the maximum cache memory amount.

Then, the analysis unit 502 refers to the acquired performance information and calculates the execution time of the job Jk (small cache amount) from the job start time and the job end time. The calculated execution time (small cache amount) is stored in the performance change table 700 as illustrated in FIG. 7, for example, in association with the job ID of the job Jk.

Furthermore, the analysis unit 502 calculates a performance change amount of the job Jk, based on the execution time (large cache amount) and the execution time (small cache amount) of the job Jk. The performance change amount is a change amount of a performance of the job Jk when the available cache memory amount is changed. The calculated performance change amount is stored in the performance change table 700, for example, in association with the job ID of the job Jk.

Here, stored content of the performance change table 700 will be described. The performance change table 700 is implemented, for example, by a storage device such as the memory 202 or the disk 204. Here, jobs A to F will be described as examples of the jobs J1 to Jm.

FIG. 7 is an explanatory diagram illustrating an example of the stored content of the performance change table 700. In FIG. 7, the performance change table 700 includes fields of an execution time (small cache amount), an execution time (large cache amount), and a performance change amount and stores pieces of performance change information 700-1 to 700-6 as records by setting information in each field.

Here, the job ID is an identifier that uniquely identifies the job Jk. The execution time (small cache amount) indicates an execution time (unit: seconds) of the job Jk under the environment in which the cache memory CM is not limited. The execution time (large cache amount) indicates an execution time (unit: seconds) of the job Jk under the environment in which the cache memory CM is limited to be minimum.

The performance change amount indicates a performance change amount (unit: %) of the job Jk that is improved when the available cache memory amount is increased. Here, the performance change amount is set as a change amount (unit: %) of the performance of the job Jk that is improved when the available cache memory amount is increased. The performance change amount corresponds to, for example, a decrease in the execution time.

For example, the analysis unit 502 can obtain the performance change amount of the job Jk from the execution time (small cache amount) and the execution time (large cache amount) in the performance change table 700, using the following formula (1).

Performance change amount=100−{execution time (large cache amount)/execution time (small cache amount)}×100 (1)

For example, the performance change information 700-1 indicates an execution time (small cache amount) “62 seconds”, an execution time (large cache amount) “50 seconds”, and a performance change amount “19%” of the job A.

As a result, the analysis unit 502 can acquire the performance change information (for example, performance change information 700-1 to 700-6) that indicates the change amount of the execution time when each job Jk is executed while changing the cache memory amount available for each job Jk, for each job Jk. The second information 120 illustrated in FIG. 1 corresponds to, for example, the performance change table 700.

The classification unit 503 performs first classification based on the access characteristics information. Here, the first classification is processing for classifying the jobs J1 to Jm into a job that has the first tendency for tending to deprive the cache memory CM and a job that has the second tendency for tending to be deprived the cache memory CM.

For example, the classification unit 503 refers to the access characteristic table 600 illustrated in FIG. 6, and classifies the jobs A to F into the job that has the first tendency for tending to deprive the cache memory CM and the job that has the second tendency for tending to be deprived the cache memory CM, using an existing clustering method. The existing clustering method includes, for example, the k-means method.

For example, in a case where the k-means method is applied to the access characteristics information 600-1 to 600-6 in the access characteristic table 600, the jobs A to F are classified into the jobs A to C that have the first tendency for tending to deprive the cache memory CM and the jobs D to F that have the second tendency for tending to be deprived the cache memory CM.

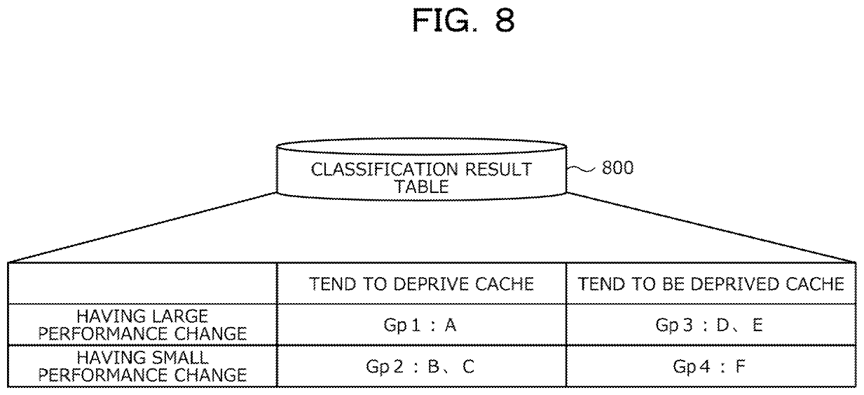

A first classification result is stored, for example, in a classification result table 800 illustrated in FIG. 8 to be described later.

Furthermore, the classification unit 503 performs second classification based on the performance change information. Here, the second classification is processing for classifying the jobs J1 to Jm into a job that has a third tendency of which a performance easily changes according to a change in the cache memory amount and a job that has a fourth tendency of which a performance does not easily change according to the change in the cache memory amount. The cache memory amount is an amount of the available cache memory CM.

For example, the classification unit 503 refers to the performance change table 700 illustrated in FIG. 7 and performs classification into the job that has the third tendency of which the performance easily changes according to the change in the cache memory amount and the job that has the fourth tendency of which the performance does not easily change according to the change in the cache memory amount, using the existing clustering method.

For example, in a case where the k-means method is applied to the performance change information 700-1 to 700-6 in the performance change table 700, the jobs A to F are classified into the jobs A, D, and E that have the third tendency of which the performance easily changes according to the change in the cache memory amount and the jobs B, C, and F that have the fourth tendency of which the performance does not easily change according to the change in the cache memory amount.

A second classification result is stored, for example, in the classification result table 800 illustrated in FIG. 8.

Here, stored content of the classification result table 800 will be described. The classification result table 800 is implemented, for example, by a storage device such as the memory 202 or the disk 204. Here, jobs A to F will be described as examples of the jobs J1 to Jm.

FIG. 8 is an explanatory diagram illustrating an example of the stored content of the classification result table 800. In FIG. 8, the classification result table 800 stores the first classification result and the second classification result. In the classification result table 800, “tend to deprive the cache” corresponds to the first tendency for tending to deprive the cache memory CM.

“Tend to be deprived the cache” corresponds to the second tendency for tending to be deprived the cache memory CM. “Having a large performance change” corresponds to the third tendency of which the performance easily changes according to the change in the cache memory amount. “Having a small performance change” corresponds to the fourth tendency of which the performance does not easily change according to the change in the cache memory amount.

Furthermore, in the classification result table 800, a group Gp1 indicates a group to which a job that “tends to deprive the cache” and “having a large performance change” belongs. A group Gp2 indicates a group to which a job that “tends to deprive the cache” and “having a small performance change” belongs. A group Gp3 indicates a group to which a job that “tends to be deprived the cache” and “having a large performance change” belongs. A group Gp4 indicates a group to which a job that “tends to be deprived the cache” and “having a small performance change” belongs.

Here, the job A belongs to the group Gp1. The jobs B and C belong to the group Gp2. The jobs D and E belong to the group Gp3. The job F belongs to the group Gp4. As a result, it is possible to classify the jobs A to F into four groups from an offline analysis result.

Here, in the offline analysis, each job Jk is executed twice. Therefore, analysis processing is 0 (m) processing. The reference m indicates the number of jobs. On the other hand, in a case where all the combinations of the jobs are executed offline, the analysis processing is 0 (m\hat{ }2) processing.

For example, in a case where the number of jobs m is “m=10”, with this method, the analysis processing ends after 20 times of job execution. On the other hand, in a case where all the combinations of the jobs are executed, the analysis processing needs 45 times of job execution. In this way, it is found that the number of times of executions in this method is equal to or less than a half of that in a case where all the combinations of the jobs are executed. Furthermore, for example, in a case where the number of jobs m is “m=20”, the processing ends after 40 times of execution with this method. Whereas, in a case where all the combinations of the jobs are executed, 190 times of execution are needed. Therefore, only about ⅕ of the number of times of execution is needed for this method.

The determination unit 504 determines a combination of jobs to be simultaneously executed, among the jobs J1 to Jm, based on the acquired access characteristics information and performance change information. For example, the determination unit 504 determines the combination of the jobs to be simultaneously executed, among the jobs J1 to Jm, based on the result of the first classification and the result of the second classification.

For example, the determination unit 504 determines the combination of the jobs to be simultaneously executed so as to combine and execute a job that has the first tendency and the third tendency and a job that has the second tendency and the fourth tendency, among the jobs J1 to Jm. The job that has the first tendency and the third tendency corresponds to the job in the group Gp1 illustrated in FIG. 8. The job that has the second tendency and the fourth tendency corresponds to the job in the group Gp4 illustrated in FIG. 8.

Furthermore, for example, the determination unit 504 determines the combination of the jobs to be simultaneously executed so as not to combine and execute a job that has the first tendency and the fourth tendency and a job that has the second tendency and the third tendency, among the jobs J1 to Jm. The job that has the first tendency and the fourth tendency corresponds to the job in the group Gp2 illustrated in FIG. 8. The job that has the second tendency and the third tendency corresponds to the job in the group Gp3 illustrated in FIG. 8.

Furthermore, there is a case where there is no job that has the second tendency and the fourth tendency (group Gp4) during the execution of the job that has the first tendency and the third tendency (group Gp1), among the jobs J1 to Jm. In this case, for example, the determination unit 504 determines the combination of the jobs to be simultaneously executed so as to combine and execute the job that has the first tendency and the fourth tendency (group Gp2) or the job that has the second tendency and the third tendency (group Gp3) with a job being executed.

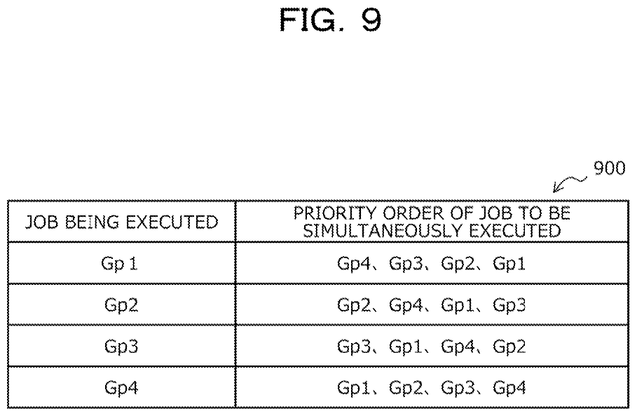

For example, the determination unit 504 refers to priority order information 900 as illustrated in FIG. 9 and determines a combination of jobs to be simultaneously executed, among the jobs A to F, based on the classification result table 800 illustrated in FIG. 8.

FIG. 9 is an explanatory diagram illustrating a specific example of priority order information. In FIG. 9, the priority order information 900 indicates a priority order of a job that is simultaneously executed with a job being executed. In a case where the job being executed is the job in the group Gp1, the priority order of the job to be simultaneously executed is “Gr4⇒Gr3⇒Gr2⇒Gr1”.

In a case where the job being executed is the job in the group Gp2, the priority order of the job to be simultaneously executed is “Gr2⇒Gr4⇒Gr1⇒Gr3”. In a case where the job being executed is the job in the group Gp3, the priority order of the job to be simultaneously executed is “Gr3⇒Gr1⇒Gr4⇒Gr2”. In a case where the job being executed is the job in the group Gp4, the priority order of the job to be simultaneously executed is “Gr1⇒Gr2⇒Gr3⇒Gr4”.

According to the priority order information 900, for example, it is possible to schedule the job in the group Gp1 and the job in the group Gp4 to be simultaneously executed. Furthermore, it is possible to schedule the job in the group Gp2 and the job in the group Gp3 not to be simultaneously executed. Furthermore, for the groups Gp1 and Gp4, the groups Gp2 and Gp3 are arranged at the second and third priority order positions so that the job in the group Gp2 and the job in the group Gp3 are not simultaneously executed.

As an example, it is assumed that the job A, among the jobs A to F, be executed. The job A is a job that belongs to the group Gp1. In this case, for example, the determination unit 504 determines the job A being executed and the job F that belongs to the group Gp4 as the combination of the jobs to be simultaneously executed.

Furthermore, it is assumed that the job B, among the jobs A to F, be executed. The job B is a job that belongs to the group Gp2. In this case, for example, the determination unit 504 determines the combination of the jobs to be simultaneously executed so as not to combine and execute the job B being executed and the jobs D and E that belong to the group Gp3. For example, the determination unit 504 determines the job B being executed and another job C that belongs to the group Gp2 as the combination of the jobs to be simultaneously executed.

The execution control unit 505 executes the jobs in the determined combination, among the jobs J1 to Jm. For example, it is assumed that the combination of the jobs A and F, among the jobs A to F, be determined as the combination of the jobs to be simultaneously executed. In this case, the execution control unit 505 causes the cores #1 and #2 of the CPU 201 to execute the jobs A and F.

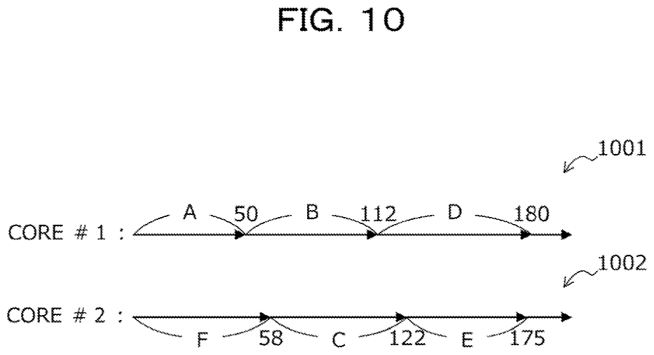

Here, an execution example in a case where the jobs A to F are scheduled according to the priority order information 900 illustrated in FIG. 9 will be described with reference to FIG. 10.

FIG. 10 is an explanatory diagram illustrating a job execution example. In FIG. 10, a graph 1001 illustrates an execution example of jobs allocated to the core #1 of the CPU 201. In the core #1, the jobs A, B, and D are executed in order. Furthermore, a graph 1002 illustrates an execution example of jobs allocated to the core #2 of the CPU 201. In the core #2, the jobs F, C, and E are executed in order.

Here, among the jobs A to F, first, the job A in the group Gp1 and the job F in the group Gp4 are simultaneously executed. Thereafter, a combination of the jobs B and C and a combination of the jobs D and E are scheduled to be simultaneously executed so that the jobs B and C in the group Gp2 and the jobs D and E in the group Gp3 are not simultaneously executed.

According to the graphs 1001 and 1002, it is found that the combination of the job A in the group Gp1 and the job F in the group Gp4 that contributes to improve a performance is executed for 50 seconds. Furthermore, it is found that an execution time of the combination of the job C in the group Gp2 and the job D in the group Gp3 that deteriorates the performance is suppressed to 10 seconds.

Note that, here, although it is assumed that the cores #1 and #2 of the CPU 201 simultaneously execute two jobs, the embodiment is not limited to this. For example, it is assumed that the cores #1 to #n of the CPU 201 simultaneously execute three or more jobs. In this case, for example, the determination unit 504 determines the combination of the jobs to be simultaneously executed, according to the priority order information 900, by focusing on any one of jobs being executed. At this time, for example, the determination unit 504 may determine the combination of the jobs to be simultaneously executed, so that only the job in the group Gp1 and the job in the group Gp4 move, as possible. Furthermore, for example, the determination unit 504 may determine the combination of the jobs to be simultaneously executed so as not to combine the job in the group Gp2 and the job in the group Gp3, as possible.

(Various Processing Procedures of Job Scheduling Device 200)

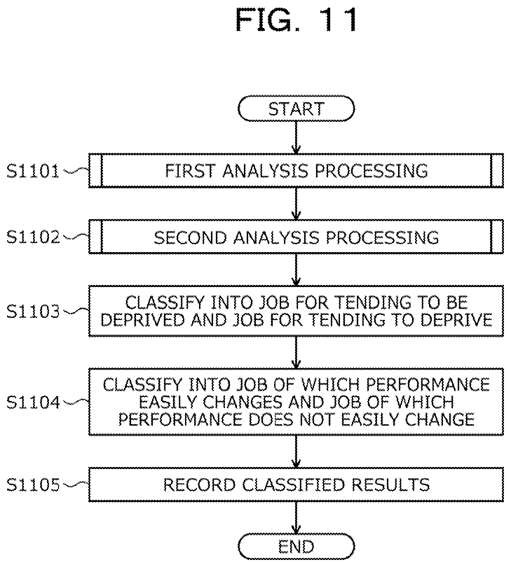

Next, various processing procedures of the job scheduling device 200 will be described. First, an offline processing procedure of the job scheduling device 200 will be described with reference to FIG. 11. The offline processing is executed, for example, prior to an actual operation of the jobs J1 to Jm.

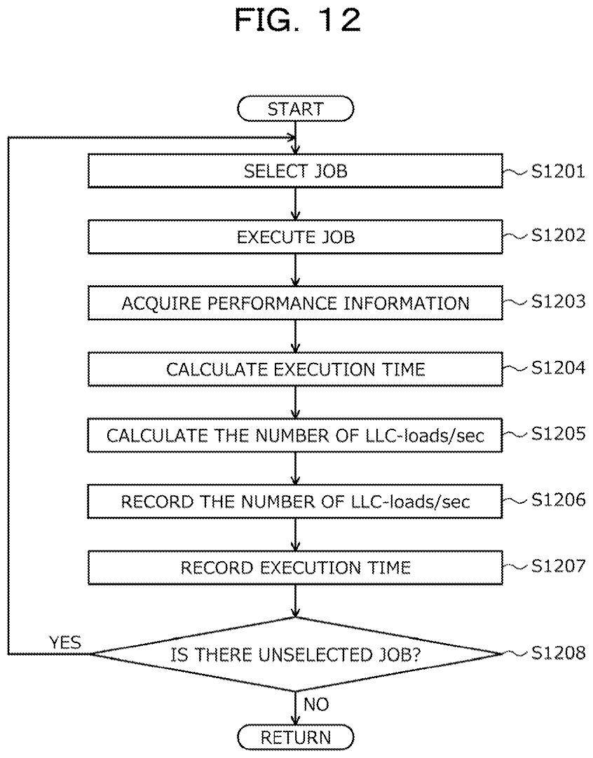

FIG. 11 is a flowchart illustrating an example of the offline processing procedure of the job scheduling device 200. In the flowchart in FIG. 11, first, the job scheduling device 200 executes first analysis processing (step S1101). The first analysis processing is processing for analyzing access characteristics to the cache memory CM of each job Jk. A specific processing procedure of the first analysis processing will be described later with reference to FIG. 12.

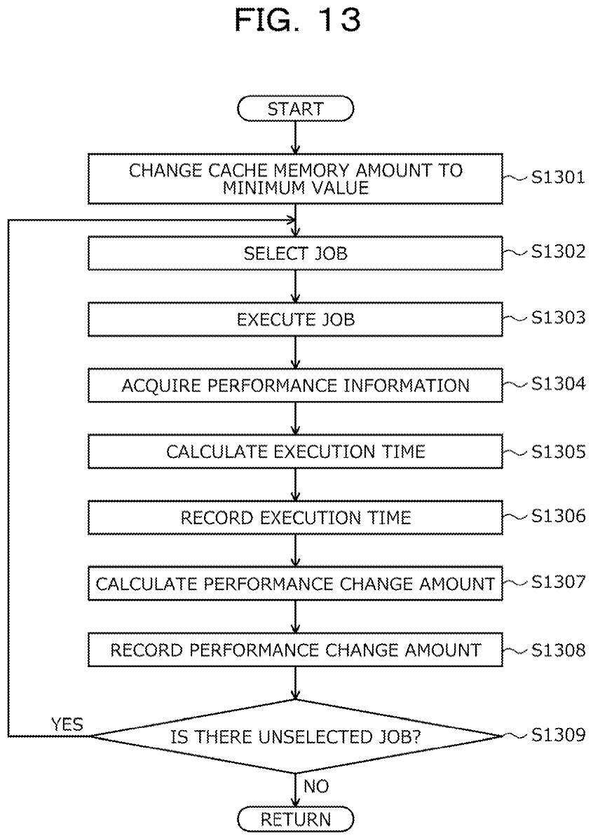

Next, the job scheduling device 200 executes second analysis processing (step S1102). The second analysis processing is processing for analyzing a performance change of each job according to a change in a cache memory amount available for each job Jk. A specific processing procedure of the second analysis processing will be described later with reference to FIG. 13.

Then, the job scheduling device 200 classifies the jobs J1 to Jm into the job that has the first tendency for tending to deprive the cache memory CM and the job that has the second tendency for tending to be deprived the cache memory CM, based on a result of the first analysis processing (access characteristic table 600) (step S1103).

Next, the job scheduling device 200 classifies the jobs J1 to Jm into the job that has the third tendency of which the performance easily changes according to the change in the cache memory amount and the job that has the fourth tendency of which the performance does not easily change according to the change in the cache memory amount, based on a result of the second analysis processing (performance change table 700) (step S1104).

Then, the job scheduling device 200 records the results of classification in steps S1103 and S1104 in the classification result table 800 (step S1105) and ends the series of processing in this flowchart.

As a result, the job scheduling device 200 can classify the jobs J1 to Jm into four groups, from the access characteristics of each job Jk to the cache memory CM and the performance change of each job Jk caused by the change in the available cache memory amount.

Next, the specific processing procedure of the first analysis processing indicated in step S1101 will be described with reference to FIG. 12.

FIG. 12 is a flowchart illustrating an example of the specific processing procedure of the first analysis processing. In the flowchart in FIG. 12, first, the job scheduling device 200 selects an unselected job Jk, which is not selected, from among the jobs J1 to Jm (step S1201). Then, the job scheduling device 200 executes the selected job Jk under the environment in which all the cache memory CM can be used (step S1202).

Next, the job scheduling device 200 acquires performance information from the OS 302 (step S1203). Then, the job scheduling device 200 refers to the acquired performance information and calculates an execution time (large cache amount) of the job Jk (step S1204). Next, the job scheduling device 200 refers to the acquired performance information and calculates the number of LLC-loads/sec of the job Jk (step S1205).

Then, the job scheduling device 200 records the calculated number of LLC-loads/sec in the access characteristic table 600 in association with the job ID of the job Jk (step S1206). Next, the job scheduling device 200 records the calculated execution time (large cache amount) in the performance change table 700 in association with the job ID of the job Jk (step S1207).

Then, the job scheduling device 200 determines whether or not there is an unselected job that is not selected, from among the jobs J1 to Jm (step S1208). Here, in a case where there is an unselected job (step S1208: Yes), the job scheduling device 200 returns to step S1201.

On the other hand, there is no unselected job (step S1208: No), the job scheduling device 200 returns to the step in which the first analysis processing is called.

As a result, the job scheduling device 200 can analyze the access characteristics of each job Jk to the cache memory CM. Furthermore, the job scheduling device 200 can calculate the execution time (large cache amount) when the job Jk is executed under the environment in which all the cache memory CM can be used.

Next, the specific processing procedure of the second analysis processing indicated in step S1102 will be described with reference to FIG. 13.

FIG. 13 is a flowchart illustrating an example of the specific processing procedure of the second analysis processing. In the flowchart in FIG. 13, first, the job scheduling device 200 changes an available cache memory amount to a minimum value (step S1301). Then, the job scheduling device 200 selects an unselected job Jk that is not selected, from among the jobs J1 to Jm (step S1302).

Next, the job scheduling device 200 executes the selected job Jk under an environment in which the available cache memory amount is limited to be minimum (step S1303). Then, the job scheduling device 200 acquires performance information from the OS 302 (step S1304).

Next, the job scheduling device 200 refers to the acquired performance information and calculates the execution time (small cache amount) of the job Jk (step S1305). Then, the job scheduling device 200 records the calculated execution time (small cache amount) in the performance change table 700 in association with the job ID of the job Jk (step S1306).

Next, the job scheduling device 200 calculates a performance change amount of the job Jk from the execution time (small cache amount) and the execution time (large cache amount) in the performance change table 700 (step S1307). Then, the job scheduling device 200 records the calculated performance change amount in the performance change table 700 in association with the job ID of the job Jk (step S1308).

Next, the job scheduling device 200 determines whether or not there is an unselected job that is not selected from among the jobs J1 to Jm (step S1309). Here, in a case where there is an unselected job (step S1309: Yes), the job scheduling device 200 returns to step S1302.

On the other hand, there is no unselected job (step S1309: No), the job scheduling device 200 returns to the step in which the second analysis processing is called.

As a result, the job scheduling device 200 can calculate the performance change amount of the job Jk improved when the available cache memory amount is increased.

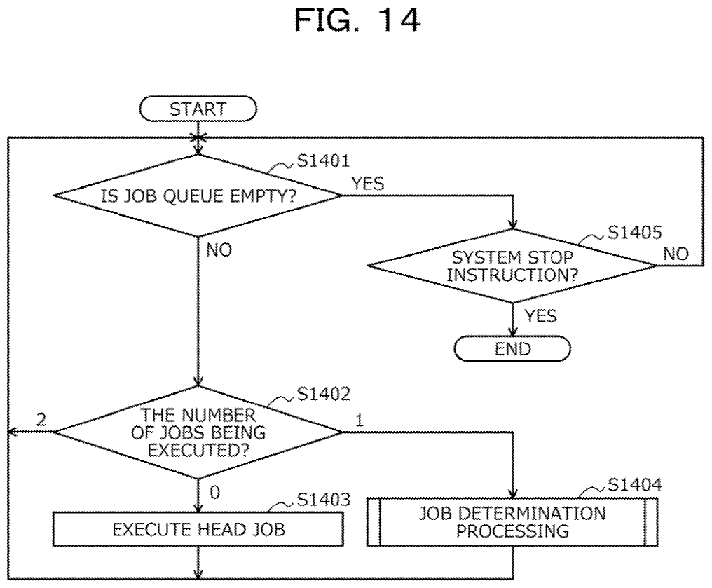

Next, a job scheduling processing procedure of the job scheduling device 200 will be described with reference to FIG. 14. The job scheduling processing is executed, for example, in response to execution requests of the jobs J1 to Jm. As the job Jk, for example, a job for performing simulation of tsunami movements or a job for performing simulation of atmospheric movements. Each job Jk is executed, for example, a plurality of times while changing parameters. For example, there is a case where the job J1 is executed a few dozen times while changing the parameters.

Here, a case will be described as an example in which two jobs are simultaneously executed on the CPU 201. Note that execution the offline processing illustrated in FIG. 11 may be started in response to the execution requests of the jobs J1 to Jm. In this case, the job scheduling processing may be executed upon completion of the offline processing.

FIG. 14 is a flowchart illustrating an example of the job scheduling processing procedure of the job scheduling device 200. In the flowchart in FIG. 14, first, the job scheduling device 200 determines whether or not a job queue is empty (step S1401).

Here, in a case where the job queue is not empty (step S1401: No), the job scheduling device 200 determines which one of zero to two the number of jobs being executed is (step S1402). Here, in a case where the number of jobs being executed is zero (step S1402: 0), the job scheduling device 200 executes the head job of the job queue (step S1403) and returns to step S1401.

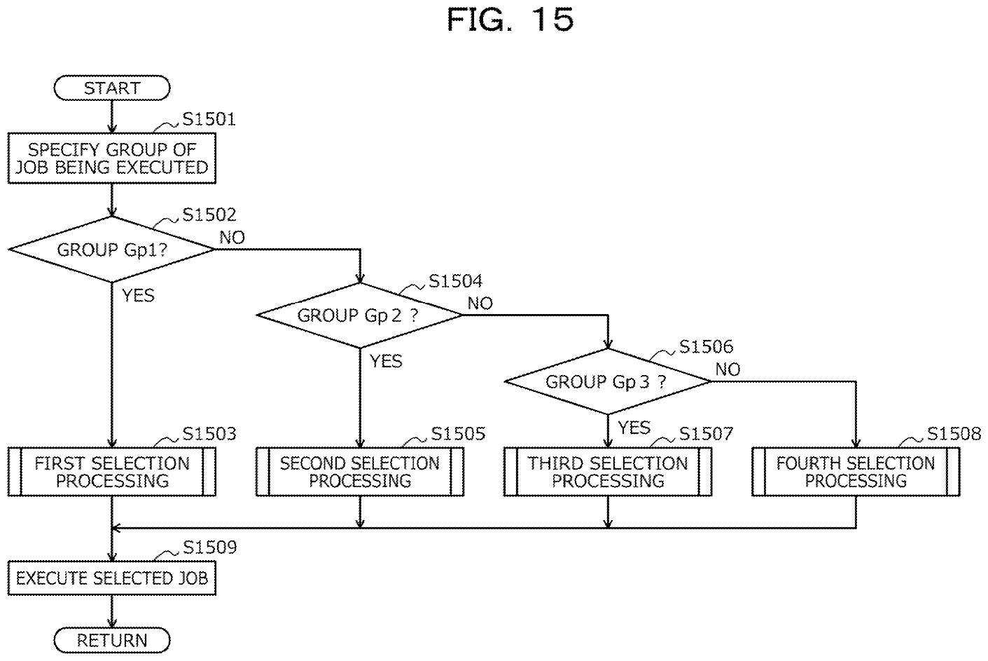

Furthermore, in a case where the number of jobs being executed is one in step S1402 (step S1402: 1), the job scheduling device 200 executes job determination processing (step S1404) and returns to step S1401. The job determination processing is processing for determining a job to be simultaneously executed with the job being executed. A specific processing procedure of the job determination processing will be described later with reference to FIG. 15.

Furthermore, in a case where the number of jobs being executed is two in step S1402 (step S1402: 2), the job scheduling device 200 returns to step S1401.

Furthermore, in a case where the job queue is empty in step S1401 (step S1401: Yes), the job scheduling device 200 determines whether or not a system stop instruction is received (step S1405). The system stop instruction is received, for example, from a client terminal (not illustrated).

Here, in a case where the system stop instruction is not received (step S1405: No), the job scheduling device 200 returns to step S1401. On the other hand, in a case where the system stop instruction is received (step S1405: Yes), the job scheduling device 200 ends the series of processing in this flowchart.

As a result, the job scheduling device 200 can execute the jobs J1 to Jm in an efficient order.

Next, the specific processing procedure of the job determination processing indicated in step S1404 will be described with reference to FIG. 15.

FIG. 15 is a flowchart illustrating an example of the specific processing procedure of the job determination processing. In the flowchart in FIG. 15, first, the job scheduling device 200 refers to the classification result table 800 and specifies a group of a job being executed from among the groups Gp1 to Gp4 (step S1501).

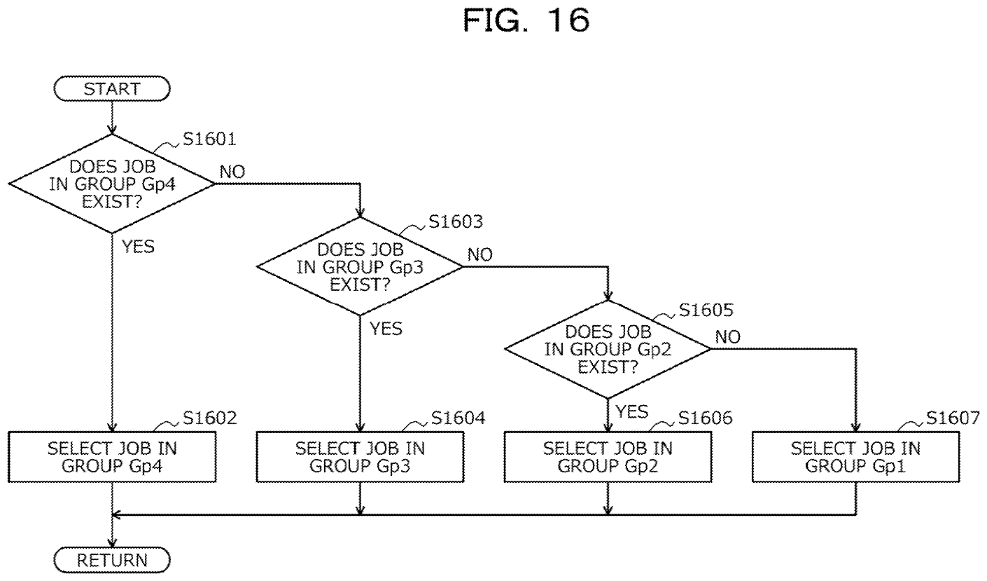

Next, the job scheduling device 200 determines whether or not the specified group is the group Gp1 (step S1502). Here, in a case of the group Gp1 (step S1502: Yes), the job scheduling device 200 executes first selection processing (step S1503) and proceeds to step S1509. The first selection processing is processing for selecting a job to be simultaneously executed with the job being executed. A specific processing procedure of the first selection processing will be described with reference to FIG. 16.

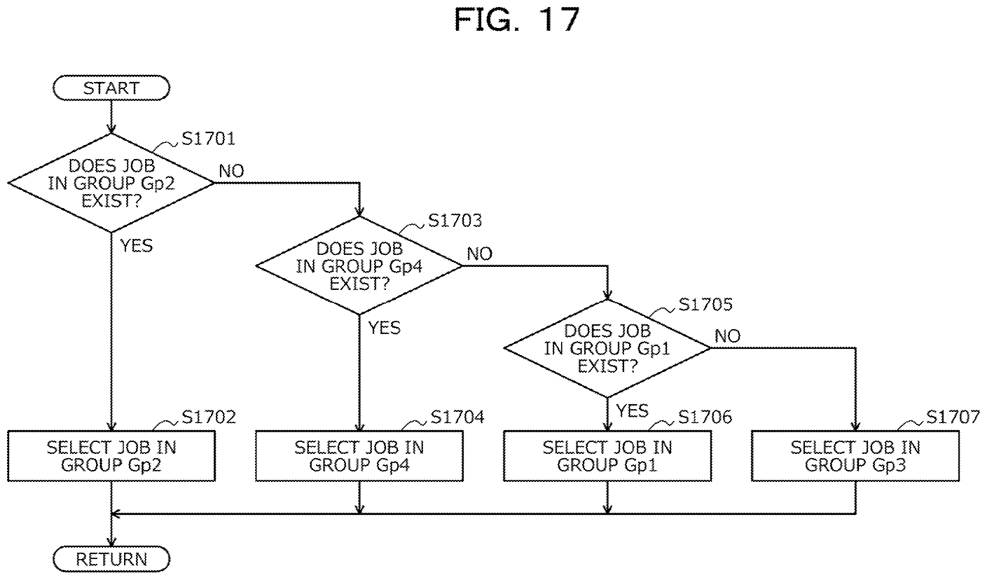

Furthermore, in a case where the specified group is not the group Gp1 in step S1502 (step S1502: No), the job scheduling device 200 determines whether or not the specified group is the group Gp2 (step S1504). Here, in a case of the group Gp2 (step S1504: Yes), the job scheduling device 200 executes second selection processing (step S1505) and proceeds to step S1509. The second selection processing is processing for selecting a job to be simultaneously executed with the job being executed. A specific processing procedure of the second selection processing will be described later with reference to FIG. 17.

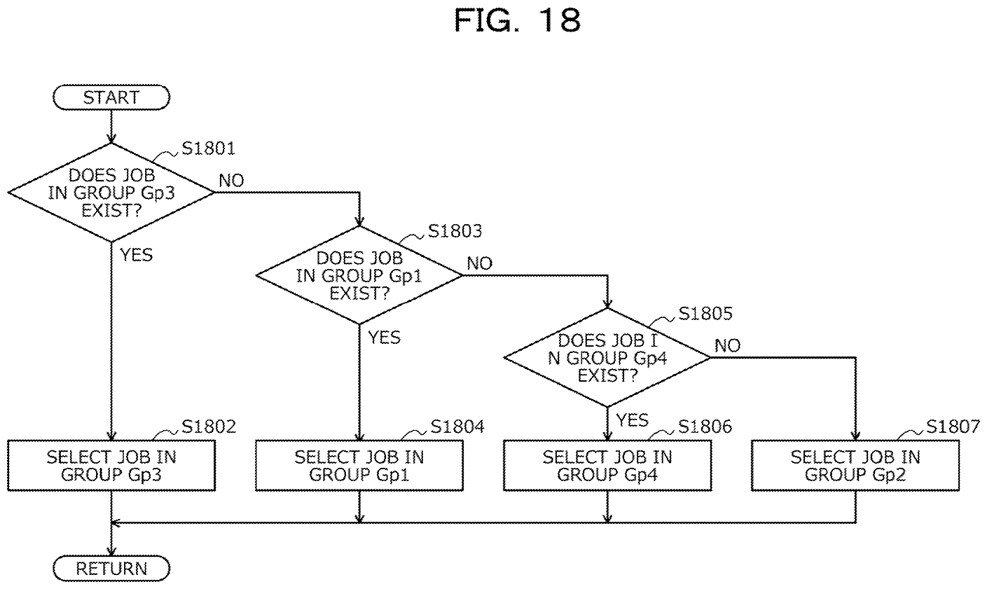

Furthermore, in a case where the specified group is not the group Gp2 in step S1504 (step S1504: No), the job scheduling device 200 determines whether or not the specified group is the group Gp3 (step S1506). Here, in a case of the group Gp3 (step S1506: Yes), the job scheduling device 200 executes third selection processing (step S1507) and proceeds to step S1509. The third selection processing is processing for selecting a job to be simultaneously executed with the job being executed. A specific processing procedure of the third selection processing will be described later with reference to FIG. 18.

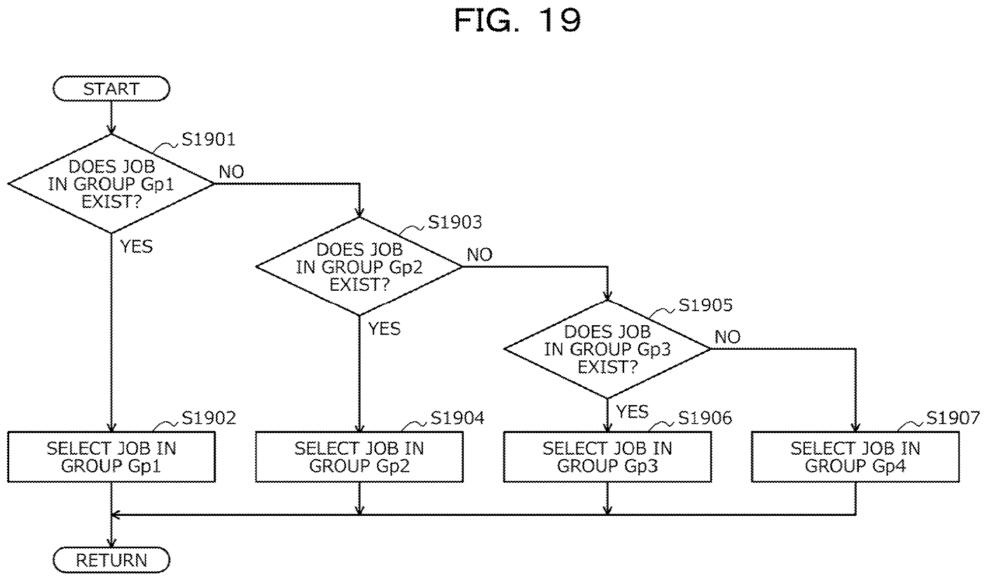

Furthermore, in a case where the specified group is not the group Gp3 in step S1506 (step S1506: No), the job scheduling device 200 executes fourth selection processing (step S1508). The fourth selection processing is processing for selecting a job to be simultaneously executed with the job being executed. A specific processing procedure of the fourth selection processing will be described later with reference to FIG. 19.

Then, the job scheduling device 200 executes the selected job (step S1509) and returns to the step in which the job determination processing is called.

As a result, the job scheduling device 200 can select the jobs to be simultaneously executed, according to the group to which the job being executed belongs, among the groups Gp1 to Gp4.

Next, the specific processing procedure of the first selection processing indicated in step S1503 will be described with reference to FIG. 16.

FIG. 16 is a flowchart illustrating an example of the specific processing procedure of the first selection processing. In the flowchart in FIG. 16, first, the job scheduling device 200 determines whether or not the job in the group Gp4 exists in the job queue (step S1601). Here, in a case where the job in the group Gp4 exists (step S1601: Yes), the job scheduling device 200 selects the job in the group Gp4 (step S1602) and returns to the step in which the first selection processing is called.

Furthermore, in a case where the job in the group Gp4 does not exist in step S1601 (step S1601: No), the job scheduling device 200 determines whether or not the job in the group Gp3 exists in the job queue (step S1603). Here, in a case where the job in the group Gp3 exists (step S1603: Yes), the job scheduling device 200 selects the job in the group Gp3 (step S1604) and returns to the step in which the first selection processing is called.

Furthermore, in a case where the job in the group Gp3 does not exist in step S1603 (step S1603: No), the job scheduling device 200 determines whether or not the job in the group Gp2 exists in the job queue (step S1605). Here, in a case where the job in the group Gp2 exists (step S1605: Yes), the job scheduling device 200 selects the job in the group Gp2 (step S1606) and returns to the step in which the first selection processing is called.

Furthermore, in a case where the job in the group Gp2 does not exist in step S1605 (step S1605: No), the job scheduling device 200 selects the job in the group Gp1 (step S1607) and returns to the step in which the first selection processing is called.

As a result, the job scheduling device 200 can schedule the job in the group Gp1 and the job in the group Gp4 that are being executed to be simultaneously executed. Furthermore, the job scheduling device 200 can preferentially select the jobs in the groups Gp2 and Gp3 so that the job in the group Gp2 and the job in the group Gp3 are not simultaneously executed when the job in the group Gp4 does not exist.

Next, the specific processing procedure of the second selection processing indicated in step S1505 will be described with reference to FIG. 17.

FIG. 17 is a flowchart illustrating an example of the specific processing procedure of the second selection processing. In the flowchart in FIG. 17, first, the job scheduling device 200 determines whether or not the job in the group Gp2 exists in the job queue (step S1701). Here, in a case where the job in the group Gp2 exists (step S1701: Yes), the job scheduling device 200 selects the job in the group Gp2 (step S1702) and returns to the step in which the second selection processing is called.

Furthermore, in a case where the job in the group Gp2 does not exist in step S1701 (step S1701: No), the job scheduling device 200 determines whether or not the job in the group Gp4 exists in the job queue (step S1703). Here, in a case where the job in the group Gp4 exists (step S1703: Yes), the job scheduling device 200 selects the job in the group Gp4 (step S1704) and returns to the step in which the second selection processing is called.

Furthermore, in a case where the job in the group Gp4 does not exist in step S1703 (step S1703: No), the job scheduling device 200 determines whether or not the job in the group Gp1 exists in the job queue (step S1705). Here, in a case where the job in the group Gp1 exists (step S1705: Yes), the job scheduling device 200 selects the job in the group Gp1 (step S1706) and returns to the step in which the second selection processing is called.

Furthermore, in a case where the job in the group Gp1 does not exist in step S1705 (step S1705: No), the job scheduling device 200 selects the job in the group Gp3 (step S1707) and returns to the step in which the second selection processing is called.

As a result, the job scheduling device 200 can schedule the job in the group Gp2 and the job in the group Gp3 that are being executed not to be simultaneously executed.

Next, the specific processing procedure of the third selection processing indicated in step S1507 will be described with reference to FIG. 18.

FIG. 18 is a flowchart illustrating an example of the specific processing procedure of the third selection processing. In the flowchart in FIG. 18, first, the job scheduling device 200 determines whether or not the job in the group Gp3 exists in the job queue (step S1801). Here, in a case where the job in the group Gp3 exists (step S1801: Yes), the job scheduling device 200 selects the job in the group Gp3 (step S1802) and returns to the step in which the third selection processing is called.

Furthermore, in a case where the job in the group Gp3 does not exist in step S1801 (step S1801: No), the job scheduling device 200 determines whether or not the job in the group Gp1 exists in the job queue (step S1803). Here, in a case where the job in the group Gp1 exists (step S1803: Yes), the job scheduling device 200 selects the job in the group Gp1 (step S1804) and returns to the step in which the third selection processing is called.

Furthermore, in a case where the job in the group Gp1 does not exist in step S1803 (step S1803: No), the job scheduling device 200 determines whether or not the job in the group Gp4 exists in the job queue (step S1805). Here, in a case where the job in the group Gp4 exists (step S1805: Yes), the job scheduling device 200 selects the job in the group Gp4 (step S1806) and returns to the step in which the third selection processing is called.

Furthermore, in a case where the job in the group Gp4 does not exist in step S1805 (step S1805: No), the job scheduling device 200 selects the job in the group Gp2 (step S1807) and returns to the step in which the third selection processing is called.

As a result, the job scheduling device 200 can schedule the job in the group Gp3 and the job in the group Gp2 that are being executed not to be simultaneously executed.

Next, the specific processing procedure of the fourth selection processing indicated in step S1508 will be described with reference to FIG. 19.

FIG. 19 is a flowchart illustrating an example of the specific processing procedure of the fourth selection processing. In the flowchart in FIG. 19, first, the job scheduling device 200 determines whether or not the job in the group Gp1 exists in the job queue (step S1901). Here, in a case where the job in the group Gp1 exists (step S1901: Yes), the job scheduling device 200 selects the job in the group Gp1 (step S1902) and returns to the step in which the fourth selection processing is called.

Furthermore, in a case where the job in the group Gp1 does not exist in step S1901 (step S1901: No), the job scheduling device 200 determines whether or not the job in the group Gp2 exists in the job queue (step S1903). Here, in a case where the job in the group Gp2 exists (step S1903: Yes), the job scheduling device 200 selects the job in the group Gp2 (step S1904) and returns to the step in which the fourth selection processing is called.

Furthermore, in a case where the job in the group Gp2 does not exist in step S1903 (step S1903: No), the job scheduling device 200 determines whether or not the job in the group Gp3 exists in the job queue (step S1905). Here, in a case where the job in the group Gp3 exists (step S1905: Yes), the job scheduling device 200 selects the job in the group Gp3 (step S1906) and returns to the step in which the fourth selection processing is called.

Furthermore, in a case where the job in the group Gp3 does not exist in step S1905 (step S1905: No), the job scheduling device 200 selects the job in the group Gp4 (step S1907) and returns to the step in which the fourth selection processing is called.

As a result, the job scheduling device 200 can schedule the job in the group Gp4 and the job in the group Gp1 that are being executed to be simultaneously executed. Furthermore, the job scheduling device 200 can preferentially select the jobs in the groups Gp2 and Gp3 so that the job in the group Gp2 and the job in the group Gp3 are not simultaneously executed when the job in the group Gp1 does not exist.

### Another System Configuration Example

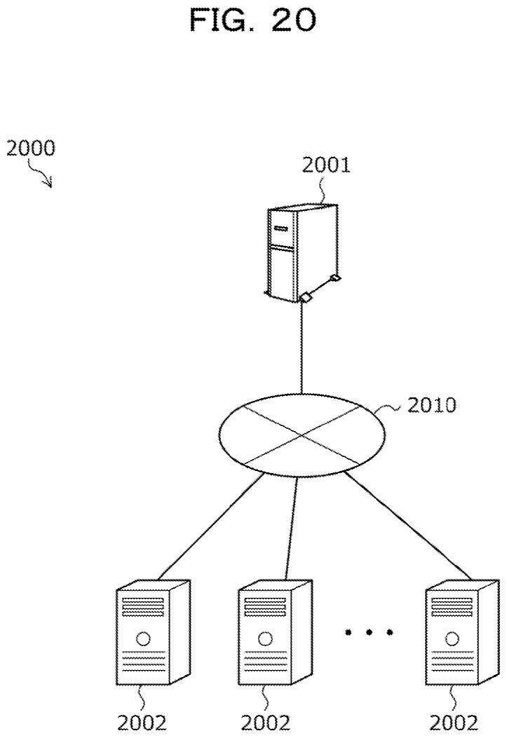

The job scheduling device 200 may be applied to a system that includes a plurality of servers, for example, a high performance computing (HPC) environment. Here, another system configuration example will be described with reference to FIG. 20. Here, a case will be described where the job scheduling device 200 is applied to a management node 2001.

FIG. 20 is an explanatory diagram illustrating another system configuration example. In FIG. 20, an information processing system 2000 includes a management node 2001 and a plurality of computing nodes 2002. In the information processing system 2000, the management node 2001 and the plurality of computing nodes 2002 are coupled via a wired or wireless network 2010. The network 2010 is, for example, the Internet, a local area network (LAN), a wide area network (WAN), or the like.

Here, the management node 2001 is a computer that schedules jobs. The computing node 2002 is a computer that executes a job allocated from the management node 2001. The management node 2001 and the computing node 2002 are, for example, servers.

In the information processing system 2000, the management node 2001 determines a combination of jobs to be simultaneously executed, for example, among the jobs J1 to Jm that are requested to be executed. Then, the management node 2001 allocates the jobs of the determined combination to any one of the computing nodes 2002. As a result, the computing node 2002 simultaneously executes the jobs in the combination allocated by the management node 2001.

As described above, according to the job scheduling device 200 according to the embodiment, it is possible to acquire the access characteristics information (first information) that indicates the number of accesses per unit time to the cache memory CM, for each job Jk among the jobs J1 to Jm that can share the cache memory CM. The number of accesses per unit time is, for example, the number of LLC-loads/sec. Then, according to the job scheduling device 200, it is possible to acquire the performance change information (second information) that indicates the change amount of the execution time when each job Jk is executed while changing the cache memory amount available for each job Jk, for each job Jk. Then, according to the job scheduling device 200, it is possible to determine the combination of the jobs to be simultaneously executed, among the jobs J1 to Jm, based on the acquired access characteristics information and performance change information.

As a result, the job scheduling device 200 can determine the combination of the jobs to be simultaneously executed in consideration of the performance change due to the effect of the cache memory CM that is shared between the jobs.

Furthermore, according to the job scheduling device 200, it is possible to classify the jobs J1 to Jm into the job that has the first tendency for tending to deprive the cache memory CM and the job that has the second tendency for tending to be deprived the cache memory CM, based on the access characteristics information. Furthermore, according to the job scheduling device 200, it is possible to classify the jobs J1 to Jm into the job that has the third tendency of which the performance easily changes according to the change in the cache memory amount and the job that has the fourth tendency of which the performance does not easily change according to the change in the cache memory amount, based on the performance change information. Then, according to the job scheduling device 200, it is possible to determine the combination of the jobs to be simultaneously executed, among the jobs J1 to Jm, based on the classified results.

As a result, the job scheduling device 200 can suppress the performance deterioration of the job that has a strong tendency to be deprived the cache memory CM while bringing out the performance of the job that has a strong tendency to deprive the cache memory CM.

Furthermore, according to the job scheduling device 200, it is possible to determine the combination of the jobs to be simultaneously executed so as to combine and execute the job that has the first tendency and the third tendency and the job that has the second tendency and the fourth tendency, among the jobs J1 to Jm.

As a result, the job scheduling device 200 can improve the performance so as to acquire a more cache memory amount for the job in the group Gp1 (job that has first tendency and third tendency). Furthermore, the job scheduling device 200 can suppress the deterioration in the performance even if the cache memory CM is deprived by the job simultaneously being executed, for the job in the group Gp4 (second tendency and fourth tendency).

Furthermore, according to the job scheduling device 200, it is possible to determine the combination of the jobs to be simultaneously executed so as not to combine and execute the job that has the first tendency and the fourth tendency and the job that has the second tendency and the third tendency, among the jobs J1 to Jm.

As a result, the job scheduling device 200 can prevent a performance deterioration (disadvantage) caused by reduction of the cache memory amount of the job in the group Gp3 (second tendency and third tendency) from being larger than the performance improvement (advantage) caused by increase in the cache memory amount of the job in the group Gp2 (first tendency and fourth tendency).

Furthermore, according to the job scheduling device 200, it is possible to determine the combination of the jobs to be simultaneously executed so as to combine and execute the job that has the first tendency and the fourth tendency or the job that has the second tendency and the third tendency, in a case where there is no job that has the second tendency and the fourth tendency, during the execution of the job that has the first tendency and the third tendency, among the jobs J1 to Jm.

As a result, the job scheduling device 200 can cause the job in the group Gp2 and the job in the group Gp3 not to be simultaneously executed as possible.

Furthermore, according to the job scheduling device 200, it is possible to execute the jobs of the determined combination, among the jobs J1 to Jm.

As a result, the job scheduling device 200 can execute the jobs J1 to Jm in an efficient order.

From these reasons, according to the job scheduling device 200, it is possible to acquire a high overall execution performance by suppressing the performance deterioration of the job on the side that is deprived the cache memory CM to be minimum while bringing out the performance improvement of the job on the side that deprives the cache memory CM to the maximum, when executing the jobs J1 to Jm.

Note that the scheduling method described in the present embodiment may be implemented by executing a program prepared in advance on a computer such as a personal computer or a workstation. The scheduling program is recorded on a computer-readable recording medium such as a hard disk, a flexible disk, a CD-ROM, a DVD, or a USB memory, and is read from the recording medium to be executed by the computer. Furthermore, this scheduling program may be distributed via a network such as the Internet.

Furthermore, the information processing device 101 (job scheduling device 200) described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a scheduling program for causing a computer to execute processing comprising:
acquiring first information that indicates the number of accesses per unit time for a cache memory, for each of a plurality of jobs that is able to share the cache memory;
acquiring second information that indicates a change amount of an execution time when each job is executed while changing a cache memory amount available for each job, for each job; and
determining a combination of jobs to be simultaneously executed, among the plurality of jobs, based on the acquired first information and second information.

2. The non-transitory computer-readable recording medium according to claim 1, for causing the computer to execute processing comprising:
classifying the plurality of jobs into a job that has a first tendency that tends to deprive the cache memory and a job that has a second tendency that tends to be deprived the cache memory, based on the first information; and
classifying the plurality of jobs into a job that has a third tendency of which a performance easily changes according to a change in the cache memory amount and a job that has a fourth tendency of which the performance does not easily change according to the change in the cache memory amount, based on the second information, wherein
the processing of determining
determines a combination of jobs to be simultaneously executed, among the plurality of jobs, based on classified results.

3. The non-transitory computer-readable recording medium according to claim 2, wherein
the processing of determining
determines a combination of jobs to be simultaneously executed so as to combine and execute a job that has the first tendency and the third tendency and a job that has the second tendency and the fourth tendency, among the plurality of jobs.

4. The non-transitory computer-readable recording medium according to claim 2, wherein
the processing of determining
determines a combination of jobs to be simultaneously executed so as not to combine and execute a job that has the first tendency and the fourth tendency and a job that has the second tendency and the third tendency, among the plurality of jobs.

5. The non-transitory computer-readable recording medium according to claim 3, wherein
the processing of determining
determines a combination of jobs to be simultaneously executed so as to combine and execute a job that has the first tendency and the fourth tendency or a job that has the second tendency and the third tendency in a case where there is no job that has the second tendency and the fourth tendency during execution of the job that has the first tendency and the third tendency, among the plurality of jobs.

6. The non-transitory computer-readable recording medium according to claim 1, for causing the computer to execute processing further comprising:
executing the jobs of the determined combination, among the plurality of jobs.

7. The non-transitory computer-readable recording medium according to claim 1, wherein the number of accesses per unit time is the number of reads per unit time from the cache memory.

8. A scheduling method comprising:
acquiring first information that indicates the number of accesses per unit time for a cache memory, for each of a plurality of jobs that is able to share the cache memory;
acquiring second information that indicates a change amount of an execution time when each job is executed while changing a cache memory amount available for each job, for each job; and
determining a combination of jobs to be simultaneously executed, among the plurality of jobs, based on the acquired first information and second information.

9. An information processing device comprising:
a memory; and
a processor coupled to the memory and configured to:
acquire first information that indicates the number of accesses per unit time for a cache memory, for each of a plurality of jobs that is able to share the cache memory;
acquire second information that indicates a change amount of an execution time when each job is executed while changing a cache memory amount available for each job, for each job; and
determine a combination of jobs to be simultaneously executed, among the plurality of jobs, based on the acquired first information and second information.
